(19) United States
(12) Patent Application Publication
(10) Pub. No.: US 2026/0309075 A1
(43) Pub. Date: Oct. 8, 2026

(54) CONTAINERIZED ULTRA-LOW NOX DIESEL ENGINE GENERATOR SET WITH ROOF-MOUNTED SELECTIVE CATALYTIC REDUCTION SYSTEM

(71) Applicant: Industrial Service Solutions WC, Inc., Houston, TX (US)

(72) Inventors: Paul Rembach, Houston, TX (US); Tarik Gharrafi, Dubai (AE); Jim French, Houston, TX (US); Jared Michael Oehring, Houston, TX (US); Wade Stockstill, Houston, TX (US)

(73) Assignee: Industrial Service Solutions WC, Inc., Houston, TX (US)

(21) Appl. No.: 19/714,344

(22) Filed: Jun. 19, 2026

Related U.S. Application Data
(63) Continuation-in-part of application No. 19/461,590, filed on Jan. 27, 2026.
(60) Provisional application No. 63/827,659, filed on Jun. 20, 2025.
(60) Provisional application No. 63/749,835, filed on Jan. 27, 2025.

(51) Int. Cl. F02B 63/04; F01N 1/08; F01N 3/20; F01N 3/28; F01P 3/18; F01P 5/02; F01P 5/10

(52) U.S. Cl. CPC F02B 63/044; F01N 1/08; F01N 3/2066; F01N 3/208; F01N 3/2892; F01P 3/18; F01P 5/02; F01P 5/10; F01N 2610/02; F01N 2610/1406; F01N 2900/1402; F01N 2900/1602; F01N 2900/1806

(57) ABSTRACT

A containerized generator set includes an engine and an electrical generator disposed within the interior of an enclosure, configured to generate electrical power, and a selective catalytic reduction (SCR) subsystem mounted on the roof of the enclosure. The SCR subsystem includes an exhaust gas inlet configured to receive exhaust gas from the engine, a mixer configured to receive a reductant and to mix the reductant with the exhaust gas, an SCR unit containing a catalyst and configured to reduce NOx in the exhaust gas using the reductant, and an exhaust gas outlet configured to discharge treated exhaust gas to atmosphere. The containerized generator set further includes a cooling package coupled to the enclosure and configured to provide thermal management for equipment disposed within the enclosure.

### CROSS-REFERENCE TO RELATED APPLICATION(S)

This application is related to and claims the benefit of priority from U.S. Provisional Application No. 63/827,659, titled “ULTRA LOW NOX DIESEL GENERATOR SET,” filed Jun. 20, 2025, and this application is related to and is a continuation-in-part application of U.S. Patent Application No. 19/461,590, titled “ULTRA-LOW NOX DIESEL ENGINE GENERATOR WITH SELECTIVE CATALYTIC REDUCTION ENGINEERED EXHAUST SYSTEM AND METHOD,” filed on Jan. 27, 2026, which, in turn, claims the benefit of priority from U.S. Provisional Application No. 63/749,835, titled “SCR for Diesel Generator,” filed on Jan. 27, 2025. The full disclosures of each of the foregoing are hereby incorporated by reference in their entirety for all purposes.

### BACKGROUND

### 1. Field of Disclosure

Embodiments of the present disclosure relate to systems and methods for diesel engine–driven generators configured to provide power to loads such as utility, data centers, hospitals, and universities. In particular, embodiments of the present disclosure relate to diesel generators that reduce oxides of nitrogen (NOx) emissions via an exhaust gas recirculation (EGR) engine combined with selective catalytic reduction (SCR) using an ammonia‑based reductant.

### 2.Description of Related Art

Diesel generator sets are widely deployed for prime power, standby power, islanded microgrids, and other mission‑critical loads, and must comply with stringent emissions requirements such as U.S. EPA Tier 4 Final. In many commercial offerings, NOx control is achieved by exhaust aftertreatment using selective catalytic reduction (SCR) and/or by strategies such as exhaust gas recirculation (EGR). Natural‑gas‑fueled engines can achieve comparatively lower NOx emissions, but they are often less responsive to rapid load changes and natural gas is a lower energy density fuel, which can complicate logistics.

Presently, Tier 4 Final compliant diesel generators are commonly powered by EPA Tier 2 compliant diesel engines with the addition of an SCR engineered exhaust. The SCR engineered exhaust typically uses urea as the reductant and is required to meet the Tier 4 Final exhaust gas emission requirements for their EPA Tier 2 compliant diesel engines.

Urea‑based SCR arrangements, however, present several practical and technical drawbacks. Urea has a relatively short usable life, is treated as a hazardous material, and has faced periods of limited availability and price spikes. Moreover, if an SCR dosing fault occurs, the underlying engine reverts to its baseline tier (e.g., Tier 2), forcing the unit to be taken offline to avoid emissions noncompliance. Additionally, the engineered exhaust needed for a Tier 2 diesel engine to comply with EPA Tier 4 Final specifications often adds exhaust backpressure near the limits allowed for the engine to operate efficiently. Exceeding these limits may require derating the engine’s maximum allowable power output.

While natural‑gas generator sets are often selected to achieve low NOx, this approach can strain gas‑supply infrastructure. Growing dependence on pipeline gas for generation has created volumetric stress and logistical delays for capacity expansion, with knock‑on schedule and cost impacts in regions where additional gas delivery is not readily available. These constraints underscore the need for alternatives that address NOx without incurring the supply‑chain, operability, and backpressure limitations associated with conventional urea‑SCR implementations.

### SUMMARY

Applicant recognized the problems noted above herein and conceived and developed embodiments of diesel engine generator systems with SCR subsystems and SCR control methods, according to the present disclosure, that reduce NOx emissions below Tier 4 Final levels.

In an embodiment, a containerized generator set includes an enclosure having a roof and defining an interior, an engine and an electrical generator disposed within the interior of the enclosure and configured to generate electrical power, and a selective catalytic reduction (SCR) subsystem mounted on the roof of the enclosure, the SCR subsystem including an exhaust gas inlet configured to receive exhaust gas from the engine, a mixer configured to receive a reductant and to mix the reductant with the exhaust gas, an SCR unit containing a catalyst and configured to reduce NOx in the exhaust gas using the reductant, and an exhaust gas outlet configured to discharge treated exhaust gas to atmosphere. The containerized generator set also includes a flow path that directs exhaust gas from an engine exhaust exit of the engine substantially to the exhaust gas inlet of the SCR subsystem, through the mixer and the SCR unit, and out of the exhaust gas outlet and a cooling package coupled to the enclosure and configured to provide thermal management for equipment disposed within the enclosure.

In another embodiment, a containerized generator set with roof‑mounted SCR subsystem includes an enclosure having a roof and defining an interior housing an engine and an electrical generator and a selective catalytic reduction (SCR) subsystem mounted on the roof of the enclosure. The SCR subsystem includes an exhaust gas inlet aligned with an engine exhaust exit of the engine, the exhaust gas inlet configured to receive the exhaust gas from the engine, the exhaust gas having a first concentration of nitrogen oxides, a mixer configured to receive a reductant and to mix the reductant with the exhaust gas, an SCR unit containing a catalyst and configured to reduce NOx in the exhaust gas to a second concentration of nitrogen oxides, the second concentration of nitrogen oxides being lower than the first concentration of nitrogen oxides, an exhaust silencer configured to reduce noise emitted from the containerized generator set, and an exhaust gas outlet configured to discharge treated exhaust gases to atmosphere, the SCR subsystem being arranged along the roof of the enclosure, and the arrangement routing the exhaust gas from the engine upwardly from the interior of the enclosure to the roof‑mounted SCR subsystem.

### BRIEF DESCRIPTION OF DRAWINGS

The present technology will be better understood on reading the following detailed description of non-limiting embodiments thereof, and on examining the accompanying drawings, in which:

FIG. 1 is a side view of an ultra-low NOx power generation system that includes a Tier-4-Final-compliant diesel engine with an SCR engineered exhaust subsystem, in accordance with embodiments of the present disclosure;

FIG. 2 is a top view of an ultra-low NOx power generation system that includes a Tier-4-Final-compliant diesel engine with an SCR engineered exhaust subsystem, in accordance with embodiments of the present disclosure;

FIG. 3 is a control block diagram for the operation of an ultra-low NOx power generation system, in accordance with embodiments of the present disclosure;

FIG. 4 is a flow chart of a method for controlling an SCR system for a diesel generator platform, in accordance with embodiments of the present disclosure;

FIG. 5 is a side view of an SCR system used in conjunction with a diesel generator set, in accordance with embodiments of the present disclosure;

FIG. 6 is a top view of an SCR system used in conjunction with a diesel generator set, in accordance with embodiments of the present disclosure;

FIG. 7 is a side view of an ultra-low NOx power generation system with external coolers and an external fuel tank, in accordance with embodiments of the present disclosure;

FIG. 8 is a side view of a generator set depicting a mechanical coupling between a diesel engine and a generator, in accordance with embodiments of the present disclosure;

FIGS. 9A-9C present tables of pre-injection and post-injection averages of exhaust chemicals outputted from embodiments of systems discussed herein, in accordance with embodiments of the present disclosure;

FIG. 10 presents tables of particulate matter mass concentrations and mass emission rates resulting from embodiments of systems discussed herein, in accordance with embodiments of the present disclosure;

FIG. 11 is a front view of a containerized ultra-low NOx generator set, in accordance with embodiments of the present disclosure;

FIG. 12 is a rear view of a containerized ultra-low NOx generator set, in accordance with embodiments of the present disclosure;

FIG. 13 is a top view of a containerized ultra-low NOx generator set, in accordance with embodiments of the present disclosure;

FIG. 14 is a left-side view of a containerized ultra-low NOx generator set, in accordance with embodiments of the present disclosure;

FIG. 15 is a right-side view of a containerized ultra-low NOx generator set, in accordance with embodiments of the present disclosure;

FIG. 16 is a partial cross-sectional front view of a containerized ultra-low NOx generator set, in accordance with embodiments of the present disclosure;

FIG. 17 is a partial cross-sectional rear view of a containerized ultra-low NOx generator set, in accordance with embodiments of the present disclosure;

FIG. 18 is a partial cross-sectional top view of a containerized ultra-low NOx generator set, in accordance with embodiments of the present disclosure; and

FIG. 19 is a perspective view of a containerized ultra-low NOx generator set, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/- 10 percent.

Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

Embodiments of the present disclosure generally relate to ultra‑low NOx (ULN) diesel generator systems that may pair (i) a diesel engine platform already compliant with Tier‑4‑Final emissions limits without selective catalytic reduction (SCR), with (ii) an engineered SCR exhaust subsystem supplied with an ammonia‑based reductant. As used herein, “NOx” may refer to oxides of nitrogen including NO and NO₂, and “reductant” may refer to ammonia or ammonia precursors that are delivered into the exhaust stream. Embodiments discussed herein may further integrate thermal monitoring, reductant‑dosing control, ammonia‑containment features, and generator/power‑management coordination to deliver ULN levels. Systems described herein may be single unit or parallel multi-unit plants; in addition, controls for the systems may be centralized or distributed.

In various embodiments, the generator platform may be a high‑output, multi‑megawatt diesel unit (e.g., on the order of about 3–3.15 MW at 60 Hz). In at least one embodiment, the diesel unit may be installed within an integrated enclosure that also houses switchgear, protection, automation, and communications interfaces suitable for grid parallel, islanded, or standby service. The prime mover may be a Tier‑4‑Final‑compliant engine that may achieves its baseline emissions levels without exhaust‑injected catalyst, for example, an EGR‑equipped platform, which may then be coupled to the disclosed SCR subsystem to further reduce NOx to ULN levels while preserving the diesel system’s responsiveness and energy density. Exhaust from the engine may be routed to an SCR reactor in the SCR subsystem containing one or more catalyst layers, and an upstream metering and injection unit may introduce the reductant under closed‑loop control so that the system meets the targeted post‑treatment emissions levels. In embodiments of the SCR subsystem, the SCR subsystem may be configured to receive engine exhaust and convert NOx to nitrogen and water in the presence of a catalyst while coordinated controls regulate injection of the reductant to achieve high conversion efficiency with minimized ammonia slip under steady‑state and transient loading.

The reductant may be an aqueous ammonia solution; in some embodiments, a solution of about 10% ammonia in water may be employed, while other embodiments utilize about 19% aqueous ammonia, and further variants may select concentrations within a range (for example, about 5–30% by weight) to balance reactivity, storage, and safety objectives. In various embodiments, injection may be coordinated with exhaust and/or catalyst temperature so that dosing is enabled only when the SCR operates within a defined thermal band conducive to efficient conversion and reduced slip. As such, in at least one embodiment, reductant dosing may be disabled during warm‑up or off‑spec conditions. Sensor inputs integrated within embodiments may include one or more of: upstream and downstream NOx, exhaust temperature, exhaust flow, differential pressure across the reactor, and reductant flow or pressure. In some embodiments, control logic may modulate the NH₃/NOx ratio toward a desired value near stoichiometric with safety margins to accommodate dynamic load changes.

In various embodiments of the present disclosure, the reductant supplied to the SCR subsystem comprises aqueous ammonia rather than urea. In many diesel engine generator applications, selective catalytic reduction systems commonly employ urea-based reductant delivery arrangements, and such arrangements may be used as part of an engineered exhaust system for packaged diesel units. The engine disclosed herein, however, may be a diesel engine that is compliant with Tier 4 Final emissions requirements without reliance on downstream SCR for baseline compliance, for example through in-cylinder emissions-control techniques including exhaust gas recirculation. As a result, the exhaust gas delivered from the engine to the SCR subsystem may exhibit temperatures that are lower than temperatures associated with diesel engines configured around urea-based SCR operation, particularly during low-load operation, startup, idling, or other transient operating conditions. In urea-based SCR arrangements, the introduced reductant contains a urea precursor from which ammonia is generated in the exhaust stream prior to or during catalytic NOx reduction. Under lower exhaust-temperature conditions, such urea-based arrangements may be associated with less complete conversion of the urea precursor, reduced NOx-conversion efficiency, and/or formation of deposits within the exhaust system. In contrast, by employing aqueous ammonia, the reductant introduced to the exhaust stream already contains ammonia available for participation in the SCR reaction.

In one or more embodiments, the use of aqueous ammonia may be combined with temperature-based dosing permissives, staged exhaust heating, closed-loop NOx feedback, and control of the NH₃/NOx ratio to maintain SCR operation within a desired conversion range while limiting ammonia slip. The selection of aqueous ammonia may thereby facilitate operation of the SCR subsystem with the comparatively cool exhaust profile of the disclosed engine platform (e.g., the Wabtec 250 family of engines). Embodiments of the present disclosure may thus permit further reduction of NOx from an engine that is already Tier 4 Final by itself, and may do so without requiring the aftertreatment architecture to depend upon exhaust conditions better suited to urea decomposition. In this manner, the disclosed system may achieve ultra-low NOx emissions, in some cases at levels comparable to or lower than those of natural gas fueled generator systems, while maintaining diesel engine responsiveness, rated output capability, and fuel-storage advantages associated with diesel-powered generation.

In some implementations, the SCR controller may communicate with the engine control unit and the generator supervisory system to align dosing with load, inhibit injection during start/stop sequences or fault conditions, and/or present alarm or status signals to a power‑management system that coordinates multiple sources. To improve transient performance, certain embodiments may apply a NOx‑integrator strategy in which a generator kW‑command signal is combined with a NOx‑error signal to overcome control‑loop propagation delays and PID hysteresis, thereby producing near‑instantaneous adjustment of reductant injection volume as exhaust flow changes with load. The KW command signal is the same signal used to sum the diesel engine speed error signal thus limiting RPM droop of the engine. When summed with the NOx error signal injection of the atomized aquas ammonia reductant is optimized resulting reduced fluctuations in the NOx levels of the exhaust during changes in load. If the aftertreatment subsystem is disabled for any reason, the unit may continue operating at the base engine’s Tier‑4‑Final exhaust level as a defined fallback mode, thus maintaining availability while alerting as to the changed emissions state.

Because ammonia handling requires specific precautions, in various embodiments, the system may include dedicated containment within a compartment, ventilation and/or purge control, leak detection (e.g., of ammonia), interlocks that disable dosing upon detected faults, and/or emergency‑stop logic that isolates the reductant supply. All or some of the aforementioned precautionary equipment and procedures may be integrated within an enclosure architecture suited for stationary generator deployment. In embodiments, the enclosure may be configured with separate rooms (for example, engine/generator, switchgear/controls, and cooling), structural provisions to support the SCR unit and exhaust silencer, and ancillary systems such as interior/exterior lighting and climate control for electrical equipment, while fire detection and suppression, fuel storage and conditioning, and access for maintenance are integrated into a master skid and removable enclosure. In some embodiments, the SCR subsystem may include a maintenance mode that allows safe servicing of the SCR subsystem while the generator remains online, during which the system reverts to the base engine emissions level (e.g., EPA Tier 4 Final) until aftertreatment is restored to normal operation.

As used herein, ULN levels may be characterized by representative values around about 11 parts per million by volume, dry (ppmvd) at 15% O₂, about 21 ppmvd, or approximately 0.15 g/kW‑hr, reflecting substantial reduction relative to engine‑only operation, while maintaining diesel‑generator responsiveness and fuel‑handling advantages. The ULN diesel generator with SCR exhaust may exhibit a 98.2% overall reduction from traditional diesel Tier 4 EGR system or Tier 4 SCR system alone. In some embodiments, NOx levels from the diesel generator and SCR system may be comparable to or lower than natural‑gas generator sets of similar output. In certain tests of the performance of the diesel engine with the SCR subsystem, laboratory testing has documented NOx and particulate matter (PM) levels meeting or surpassing prospective Tier‑5‑type targets at load conditions such as 10%, 50%, and 100% load.

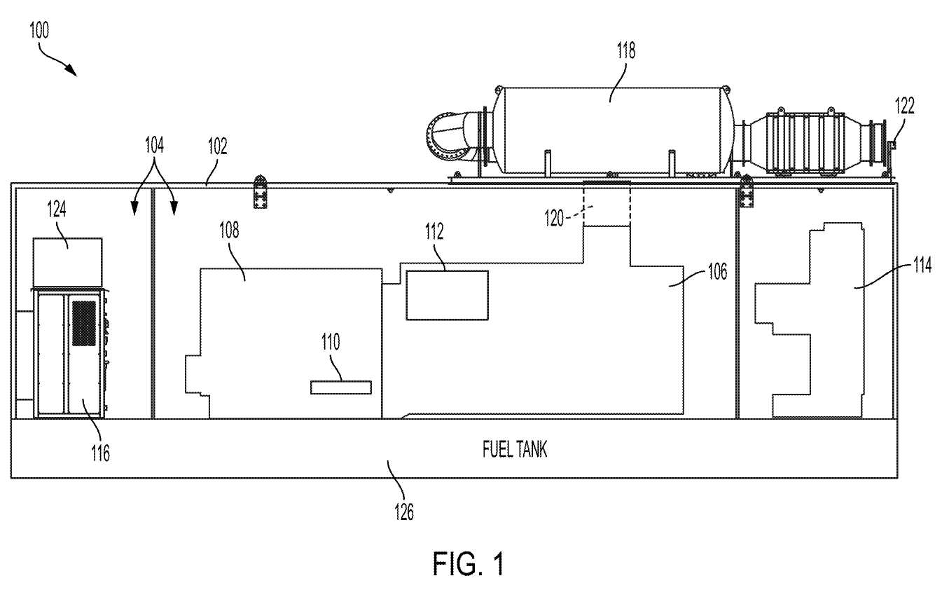

FIG. 1 is a side view of an ultra-low NOx power generation system 100 (e.g., the ULN power generation system 100, the power generation system 100, or the system 100). The power generation system 100 may include an enclosure 102 that houses various equipment, parts, or aspects of the system 100. Further, the enclosure 102 may comprise one or more rooms 104, with different dedicated equipment in different dedicated rooms 104. The one or more rooms 104 of the enclosure 102 may provide some level of separation in terms of heat, exhaust/fumes, or potential leaks produced from various types of equipment incorporated in the system 100. The enclosure 102 may be a removable enclosure bolted to master skid. Furthermore, the enclosure 102 may provide structural framing for SCR unit/silencer/exhaust, separate rooms, louvers, fans, climate control, lighting, and/or emergency egress hardware.

The system 100 includes a diesel engine 106 (e.g., an engine 106) as the prime mover, which, in some embodiments, may be a Tier-4-Final-compliant diesel engine 106. Specifically, in at least one embodiment, the engine 106 is a Wabtec Corporation 12V250SDC Tier 4 emissions compliant diesel engine. In another embodiment, the engine 106 is a Wabtec Corporation 12V250MDC Tier 4 emissions compliant diesel engine. The engine 106 may use ASTM D-975 low sulphur diesel as the BTU source of energy. However, it should be appreciated that the engine 106 may be a non-Tier-4-Final-compliant engine, may be an engine manufactured by another company, or may run on other types of diesel. The system 100 may also include an electrical generator 108 directly mechanically coupled to an output shaft (not depicted in FIG. 1) of the engine 106 such that rotational power produced by the engine 106 is directly transferred to a rotor assembly (also not depicted in FIG. 1) of the generator 108. As the engine 106 drives the rotor assembly of the generator 108, a magnetic field is induced, which ultimately produces three‑phase alternating current electrical power suitable for distribution to facility loads or grid‑connected equipment.

The generator 108 may include an electric starter 110, which may be configured to supply battery-powered cranking torque to the diesel engine 106, thereby initiating rotation of the engine 106 until combustion of diesel within the engine 106 becomes self-sustaining. Further, the diesel engine 106 may include an engine‑mounted electronic control unit 112 (e.g., ECU 112, engine ECU 112, control unit 112, engine controller 112, or controller 112), which may govern the diesel engine’s fuel and speed, manage start/idle/run transitions, monitor sensor inputs (coolant, oil, temperature/pressure, etc.), and/or enforce engine‑level permissives and trips such as overspeed. In at least one embodiment, the engine 106, the generator 108, the electric starter 110, and the controller 112 may all be housed in a single room 104 of the enclosure 102.

The system 100 may further include a diesel radiator 114 (e.g., radiator 114). The diesel radiator 114 may be a vertical cooling module that includes jacket water and aftercooler cores and provides cooling using a variable‑frequency, inverter‑driven fan. Sensors of the radiator 114 may include temperature, flow, pressure, and valve‑position sensing, and the radiator 114 may have closable intake and exhaust louvers. In at least one embodiment, the radiator 114 is housed in a dedicated room 104 within the enclosure 102. In some embodiments, the radiator 114 is housed in a separate room 104 from the engine 106 and generator 108.

The power generation system 100 may further include an integrated controls and switchgear assembly 116 (e.g., switchgear assembly 116 or assembly 116), which may generally manage power distribution, protection, and metering. More particularly, the switchgear assembly 116 may include generator switchgear with breaker protection and permissive interlocks, load‑sharing/synchronizing and voltage‑regulation controllers, Human Machine Interface (HMI) screens, ground detection, and redundant 24 VDC control power for local or automatic (PMS) operation. The assembly 116 may coordinate with the engine-mounted ECU 112 and an SCR subsystem 118 (e.g., for dosing permissives and alarms) so that electrical operations, synchronization, and emissions management function in an integrated manner across the ULN power generation system 100. The integrated controls and switchgear assembly 116 may be housed in a dedicated, climate‑controlled room 104 of the enclosure 102. In at least one embodiment the switchgear assembly 116 is housed in a separate room 104 from both: the dedicated room 104 for the engine 106 and generator 108; and the dedicated room for the cooling/radiator 114.

The SCR subsystem 118 of the system may function to remove NOx from engine exhaust in a chemical exchange process in a reactor. The catalyst in the reactor of the SCR subsystem 118 may be monolith, plate, or other geometries of catalyst. The SCR subsystem 118 may receive exhaust from the engine 106 through an exhaust inlet 120 positioned between the engine 106 and the SCR subsystem 118, the exhaust inlet 120 fluidly connecting the exhaust from the engine 106 with the SCR subsystem 118. In other words, the SCR subsystem 118 may be in fluid communication with the engine 106 and configured to receive exhaust gas through the exhaust inlet 120 that is discharged from the engine 106. In some embodiments, the exhaust from the engine 106 may already be Tier 4 certified exhaust.

After the exhaust gas undergoes the chemical exchange process in the SCR subsystem 118, the system 100 may produce an ultra-low NOx (ULN), low particulate matter exhaust output 122 (e.g., at the exhaust outlet 122). Thus, the SCR subsystem 118 may further remove NOx from the already Tier 4 certified exhaust, lowering NOx levels to below Tier 4 certified levels in the exhaust output 122. The resulting exhaust gas in the exhaust output 122 may contain levels of NOx and other contaminates that are equal to or less than the exhaust contaminates from a natural gas generator system, while the diesel engine and generator 106, 108 is still able to displace an equivalent power level to a natural gas generator system.

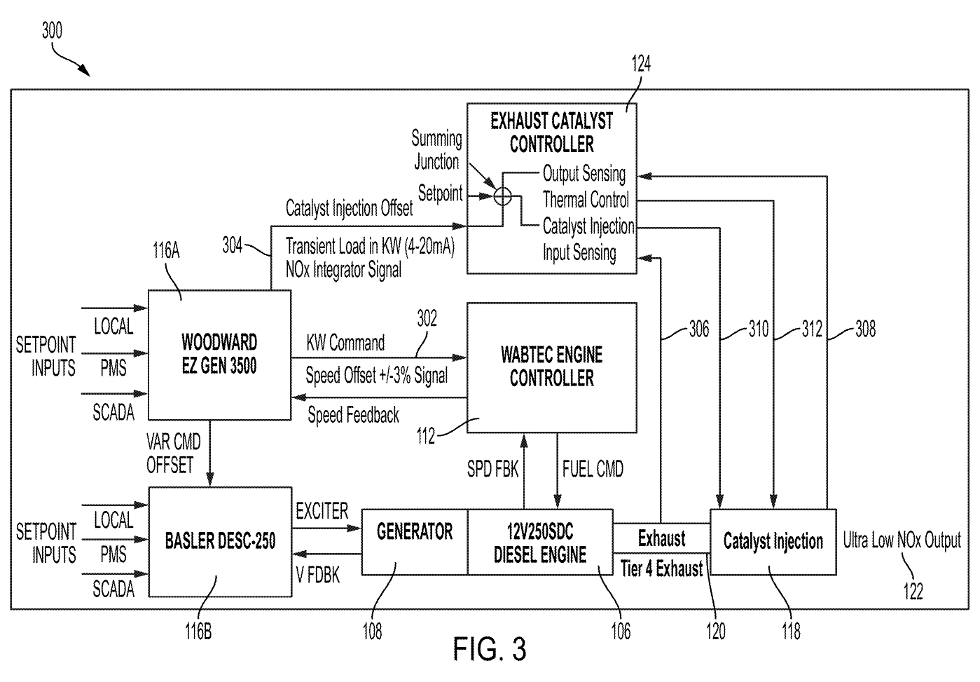

The system 100 may further include an SCR controller 124 integrated with the engine ECU 112 and generator/switchgear controls 116 to monitor and control the ammonia‑based aftertreatment in the SCR subsystem 118 as part of the exhaust path. The SCR controller 124 may interface with exhaust-stream instrumentation (such as upstream/downstream NOx sensors, exhaust temperature, and flow sensors), a reductant tank in the SCR subsystem 118, and a metering pump and injector upstream of the SCR subsystem 118. The SCR controller 124 may operate by enabling and controlling reductant dosing within a defined temperature band to achieve ultra‑low NOx levels that may be below Tier 4 Final. More details regarding the SCR controller 124 and SCR subsystem 118 are described in reference to FIG. 3.

Additionally, The power generation system 100 may include a fuel system 126 having a fuel tank configured to store the energy source of the system 100. The fuel system 126 may be integrated with a base skid of the enclosure 102 and may provide capacity for extended operation (e.g., 36 hours at 100% load). To provide the fuel to the engine 106 from the fuel tank of the fuel system 126, the fuel system 126 may include suction and return lines, isolation valves, and/or transfer pumps. Further integrated with the fuel system 126 may be sensors for pressure, flow, and fuel level, and the fuel system may include filtration and centrifuge fuel cleaning systems. Other systems incorporated into the system 100 may be a fire detection and suppression systems that may be within the enclosure 102. In some embodiments, the fire detection and suppression systems may include thermal and ionization sensors, monitoring and remote activation capability, and/or suppression tanks and valves.

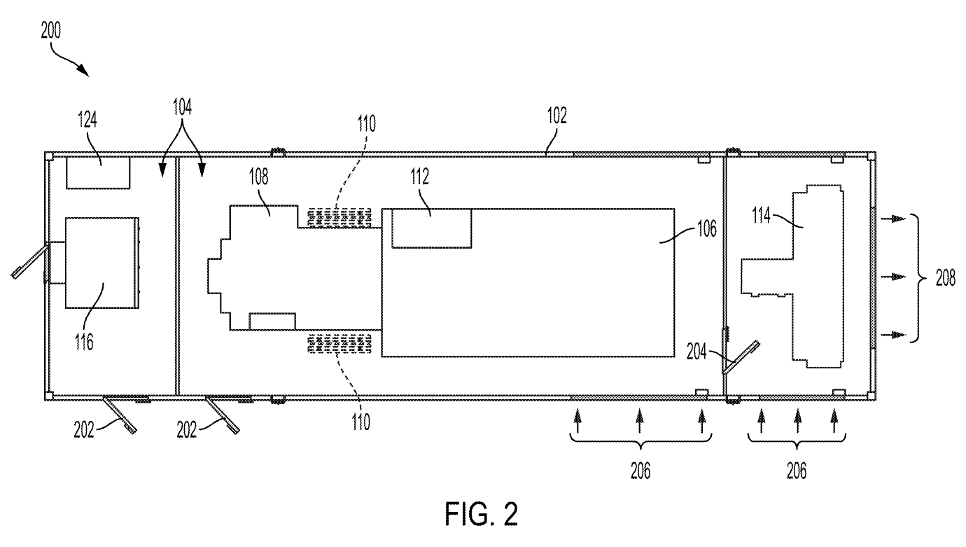

FIG. 2 is a top view of an ultra-low NOx power generation system 200 (e.g., the ULN power generation system 200, the power generation system 200, or the system 200). The power generation system 200 shown in the top view of FIG. 2 shows many similar components and equipment of the power generation system 100 that could be seen in the side view of FIG. 1. For example, the system 200 includes the enclosure 102 including the one or more rooms 104. In one room 104, the system 200 includes the diesel engine 106, the electrical generator 108 mechanically coupled to the engine 106, the electric starter 110, and the engine ECU 112. In a second room 104, FIG. 2 depicts that the system 200 includes the radiator 114 to provide cooling to the system 200. In a third room 104, the system 200 includes the integrated controls and switchgear assembly 116 and the SCR controller 124.

Further illustrated in FIG. 2, the system 200 may include one or more exterior doors or panels 202, which may be integrated into the enclosure 102 to allow servicing personnel to access the rooms 104 of the system 200 from the outside through the exterior doors 202. Additionally, the enclosure 102 may include one or more interior doors or panels 204 to allow for access between rooms 104 within the enclosure 102.

Moreover, the system 200 may include one or more air inlets 206 and one or more air outlets 208 integrated into the enclosure 102. In an embodiment, the room 104 housing the engine 106 includes air inlets 206 to supply the engine 106 with air for the combustion of diesel. The air inlets 206 may allow for high-volume cooling and ventilation flow. One of the air inlets 206 may also allow cool air to move across the radiator 114. The one or more air outlets 208 may allow for hot air, such as from the radiator 114, to escape the enclosure 102 to be replaced by cooler air. The air inlets 206 and air outlets 208 may support safe operation of adjacent rooms 104 by providing purge/ventilation capacity and monitored airflow/temperature to prevent heat build-up or hazardous accumulations within the enclosure 102.

FIG. 3 is a control block diagram 300 for the operation of an ultra-low NOx power generation system. The control block diagram 300 includes many similar components and equipment of the power generation system 100 of FIG. 1 and power generation system 200 of FIG. 2. For example, blocks in the diagram representing the diesel engine 106, the generator 108, the engine controller 112, the integrated controls and switchgear assembly 116, the SCR subsystem 118, the exhaust inlet 120, the exhaust output 122, and the SCR controller 124 are shown.

In the embodiment illustrated in FIG. 3, the diesel engine 106 is mechanically coupled to the synchronous generator 108. The engine 106 may be governed by a dedicated engine controller 112. Within the controls and switchgear assembly 116, a Woodward EZ Gen 3500 controller 116A may coordinate real‑power dispatch and speed/isochronous control in the system, while the Basler DESC‑250 Automatic Voltage Regulator 116B (e.g., AVR 116B) may regulate excitation (reactive power and terminal voltage). As depicted in FIG. 3, the engine’s lean‑NOx exhaust (e.g., Tier 4 compliant) is routed through the exhaust inlet 120 to the SCR subsystem 118 controlled by the SCR controller, which may implement selective catalytic reduction using aqueous ammonia to achieve ultra‑low NOx emissions at the exhaust outlet 122. In at least one embodiment, the engine 106 operates at 900 rpm and the generator 108 is rated 3.15 MW/4.0 MVA.

In the embodiment illustrated in FIG. 3, the prime mover in the system is a Wabtec 12V250SDC V12, turbocharged and intercooled, compression‑ignition diesel engine that, without further SCR aftertreatment, conforms with EPA Tier 4 and IMO III. In various embodiments, sensors associated with the engine 106 provide speed feedback (“SPD FBK”) and other operating telemetry to the engine controller 112 for closed‑loop fueling control (“FUEL CMD”). The engine 106 may deliver mechanical power to the generator 108, and, in at least one embodiment, the generator 108 is a brushless, 8‑pole, 60 Hz alternator with AVR‑regulated field excitation. Output from the AVR 116B may go to the rotating exciter (via “EXCITER”) in the generator 108, and there may be terminal voltage feedback (“V FDBK”) to the AVR 116B to maintain terminal voltage. The AVR 116B may implement automatic voltage regulation and reactive‑power setpoint tracking, it also may accept a VAR command offset (“VAR CMD OFFSET”) from the Woodward controller 116A to coordinate power factor and voltage profile on the generator switchgear (main AC bus).

The Woodward controller 116A may receive setpoint inputs selectable from LOCAL, PMS (Power Management System), or Supervisory Control and Data Acquisition (SCADA) sources. From these inputs and measured system conditions, the controller 116A may issue a kW command speed offset signal 302 (kW command and a fine speed‑offset of ±3%) to the engine controller 112, and, as mentioned herein, the controller 116A may forward a VAR command offset to the AVR 116B. The Woodward controller 116A may also exchange speed feedback with the engine controller 112 to support isochronous or droop modes, load sharing, and synchronization.

As mentioned herein, the 12V250SDC engine 106 produces Tier‑4 compliant exhaust without relying on an upstream catalyst. Because of this, a downstream SCR subsystem 118 can be sized for very low NOx without imposing a prohibitive derate on the engine 106, and there may be minimal baseline backpressure. The exhaust gas stream therefore may enter the catalyst injection section of the SCR subsystem 118, through the exhaust inlet 120, as a well‑conditioned feed gas for final NOx reduction to levels below Tier 4.

The SCR controller 124 of the system may aggregate multiple inputs at a summing junction to compute a commanded catalyst‑injection rate and to supervise thermal control of the reactor hardware. SCR controller inputs 304, that is, from the Woodward controller 116A to the SCR controller 124, may include: (i) a NOx integrator signal derived from downstream sensing; (ii) a transient load feed‑forward signal proportional to real‑power change (e.g., a 4–20 mA signal representing kW); and/or (iii) a catalyst‑injection offset for calibration. As mentioned herein, the NOx‑integrator strategy may inlcude a generator kW‑command signal combined with a NOx‑error signal to overcome control‑loop propagation delays and PID hysteresis, thereby producing near‑instantaneous adjustment of reductant injection volume as exhaust flow changes with load. The KW command signal may be the same signal used to sum the diesel engine speed error signal, thus limiting RPM droop of the engine. When summed with the NOx error signal, injection of the atomized aquas ammonia reductant may be optimized, resulting in reduced fluctuations in the NOx levels of the exhaust during changes in load. Regarding the SCR feed-forward, the Woodward controller 116A may publish a transient load signal to the SCR controller 124. This anticipatory term may pre‑emptively scale the dosing command during ramps and step changes occurring within the system, thereby reducing NOx excursions before the integrator path responds.

Other inputs to the SCR controller 124 may include input sensing, which is the engine exhaust sensor feedback 306 (e.g., NOx levels in the Tier 4 Final exhaust leaving the engine 106), and output sensing, which is SCR exhaust output sensor feedback 308 (e.g., NOx levels in the ultimate exhaust output 122 leaving the SCR subsystem 118). SCR exhaust output sensor feedback 308 may also include a sensor feedback measuring ammonia slip in the exhaust output 122. In some embodiments, the system is operated with a target efficiency such as approximately 95% (e.g., a slip rate of 95% would mean the system is 95% efficient).

Furthermore, the SCR controller 124 may drive catalyst injection via an ammonia pressurized feed 310 to the SCR subsystem 118 through atomizing injectors. The SCR controller 124 may also be configured to provide thermal control outputs 312 to heating elements in the SCR subsystem 118, which may function to hold the SCR within its effective temperature window. Sensor feedback to the SCR controller 124 may further include catalyst temperature, as it may be preferable to the temperature of the catalyst to stay within a defined temperature range, so the SCR controller 124, via thermal control, may control heating elements to maintain a certain catalyst temperature.

In one or more embodiments, the reductant used in the SCR may be aqueous ammonia (e.g., a ~19 wt% NH₃ solution), and the reductant may be metered to the exhaust gas in the SCR subsystem 118 via, for example, atomizing injectors. The dosing capacity and line heaters within the SCR subsystem 118 may be sized to maintain delivery across the engine’s operating envelope. For example, ammonia dosing hardware may be sized to deliver the required flow rate of reductant over the engine’s full operating range (e.g., based on the exhaust flow rate), and/or the equipment associated with the SCR subsystem 118 that provides line‑heating/heat‑tracing may be sized so the reductant can actually be delivered (i.e., pumped and injected) whenever dosing is enabled by the control logic in the SCR controller 124. Moreover, the SCR controller 124 may be configured to limit the NH₃/NOx ratio to avoid ammonia slip while sustaining conversion during load transients. The SCR subsystem 118 may also include staged heating of exhaust gas so that the SCR reaction occurs in the intended temperature band during, for example, startup and load steps. As temperature rises, the SCR controller 124 may relax preheating while continuing to supervise conversion efficiency and ammonia slip limits. With closed‑loop dosing and thermal control by the SCR controller 124 in the SCR subsystem 118, the gas in the exhaust outlet 122 may have NOx levels as low as about 11 ppmvd at 15% O₂ (≈0.15 g/kW‑hr) under full‑load conditions, which may represent reductions of approximately 90% beyond NOx levels of the engine 106 by itself and meeting or exceeding typical natural‑gas generator NOx values of comparable rating.

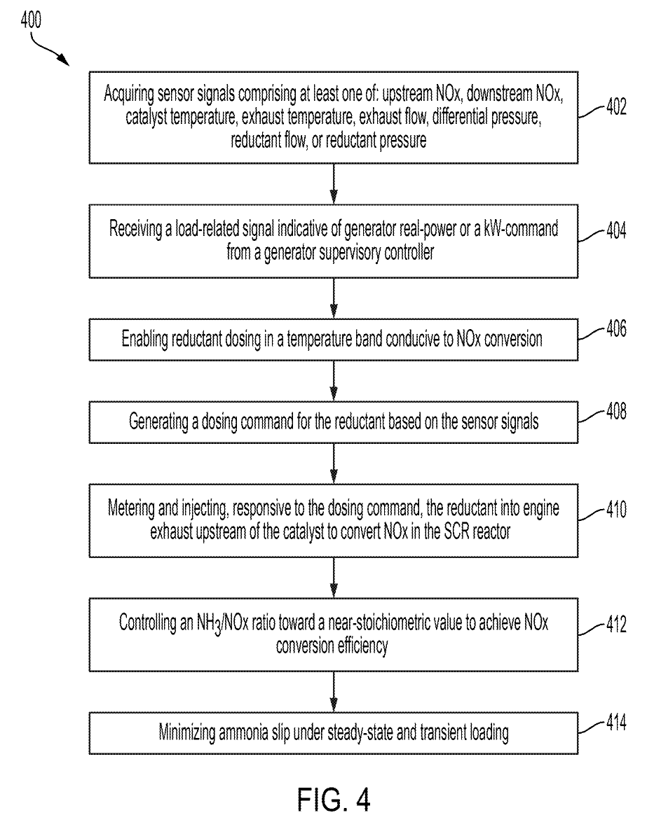

FIG. 4 is a flow chart of a method 400 of controlling a system comprising an SCR reactor, a catalyst, and a reductant. The method 400 may include acquiring sensor signals comprising at least one of: upstream NOx, downstream NOx, catalyst temperature, exhaust temperature, exhaust flow, differential pressure, reductant flow, or reductant pressure 402. The method 400 may further include receiving a load‑related signal indicative of generator real‑power or a kW‑command from a generator supervisory controller 404. Additionally, the method 400 may include enabling reductant dosing in a temperature band conducive to NOx conversion 406, and generating a dosing command for the reductant based on the sensor signals 408. The method 400 may also include metering and injecting, responsive to the dosing command, the reductant into engine exhaust upstream of the catalyst to convert NOx to nitrogen and water in the SCR reactor 410. Furthermore, the method 400 may include controlling an NH₃/NOx ratio toward a near‑stoichiometric value to achieve NOx conversion efficiency 412, and minimizing ammonia slip under steady‑state and transient loading 414.

In some embodiments, the method 400 may further include inhibiting the injection of the reductant during start or stop sequences or upon detection of a fault condition. In at least one embodiment, the method 400 may also include driving heating elements associated with the SCR reactor to maintain a catalyst temperature within the temperature band. In one or more embodiments, the method 400 may additionally include detecting an ammonia leak, and the method 400 may also include disabling dosing and isolating a reductant supply via emergency‑stop logic responsive to the leak detection.

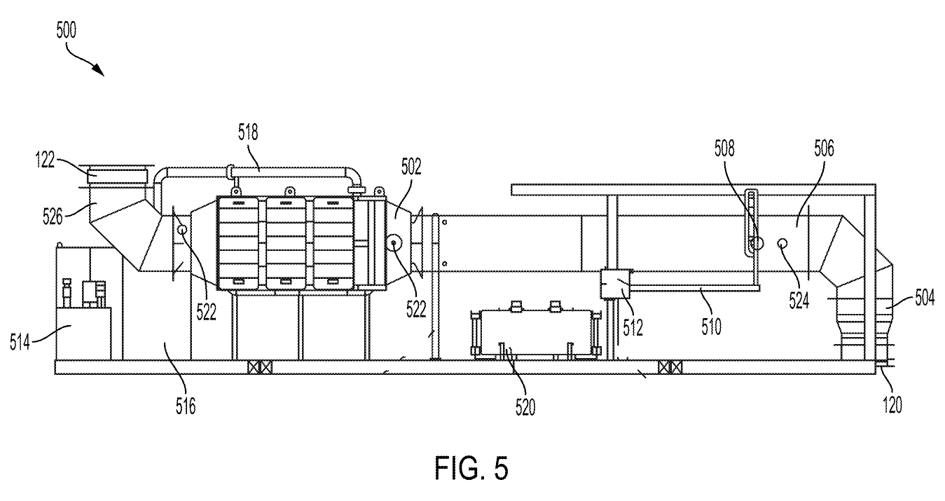

FIG. 5 is a side view of an SCR system 500 that may be used in conjunction with a diesel generator set, as discussed herein. (If used in conjunction with a larger ULN generator set system, the SCR system 500 may be referred to herein as an SCR subsystem 500.) The SCR system 500 may be used in treating exhaust gases from a diesel engine with a reductant in the presence of a catalyst. The SCR system 500 may include a main SCR unit 502, which may house the catalyst used in the SCR reaction. Exhaust gasses from the diesel engine may enter the SCR system 500 via the exhaust inlet 120. At the exhaust inlet, there may be an exhaust inlet sensor 504, which may measure and send sensor signals regarding exhaust inlet gas flow rate, exhaust inlet gas pressure, and/or exhaust inlet gas temperature. The exhaust inlet sensor 504 may also sense NOx concentration of the exhaust inlet gasses. Exhaust gasses from the exhaust inlet 120 may enter a reactant mixing section 506 where exhaust gasses contact the reductant. Reductant may be injected into the reactant mixing section 506 via an injector 508, which may be an atomizing injector. Reductant may reach the injector 508 via a dosing line 510, and the dosing line 510 may run from a doser box 512 to the injector 508. A doser box 512 may be an enclosed module that contains the equipment required to meter the correct amount of reductant, control the injection process (e.g., injection pressure, flow rate, etc.), condition the reductant (e.g., heat it, filter it, monitor it), and/or deliver the reductant to the injector 508 mounted on the reactant mixing section 506. The doser box 512 may be mounted upstream from the SCR unit 502. Reductant (e.g., ammonia) used in the SCR system 500 may be held in a reductant tank 514. From the reductant tank 514, when dosing is commanded, the reductant may flow from the reductant tank 514, to the doser box 512, through the dosing line 510, and to the injector 508 to be injected into the reactant mixing section 506 to contact exhaust gasses.

Further illustrated in FIG. 5 is a heater 516 which may heat a medium (e.g., air) when the SCR unit 502 may need to increase in temperature to maintain SCR reaction temperature with the defined temperature band for an efficient SCR reaction. The heated medium from the heater 516 may pass through a duct 518, and the duct 518 may fluidly connect the heater 516 to the SCR unit 502. Additionally, the system 500 may include a tank associated with an expansion and cooling system 520. The expansion and cooling system 520 which may cool a medium when the SCR unit 502 may need to decrease in temperature to maintain SCR reaction temperature with the defined temperature band for an efficient SCR reaction.

In addition to the exhaust inlet sensor 504, the system 500 may include one or more of various other types of sensors. One or more sensors in the system 500 may collect and send sensor signals of upstream NOx, downstream NOx, catalyst temperature, exhaust temperature, exhaust flow, differential pressure, reductant flow, and/or reductant pressure For example, one or more differential pressure transducers or sensors 522 may be positioned at one or more locations on the SCR unit 502. The differential pressure transducers 522 may measure pressure drop across the SCR unit 502. Additionally, the system 500 may include an oxidation catalyst temperature sensor 524, which may be positioned on the reaction mixing section 506, as depicted in FIG. 5. Moreover, downstream from the SCR unit, once gasses have been treated with reductant and passed through the catalyst, there may be an exhaust outlet sensor 526, which may measure and send sensor signals regarding exhaust outlet gas flow rate, exhaust outlet gas pressure, and/or exhaust outlet gas temperature at an exhaust gas outlet 122. The exhaust outlet sensor 526 may also sense NOx concentration of the exhaust outlet gasses.

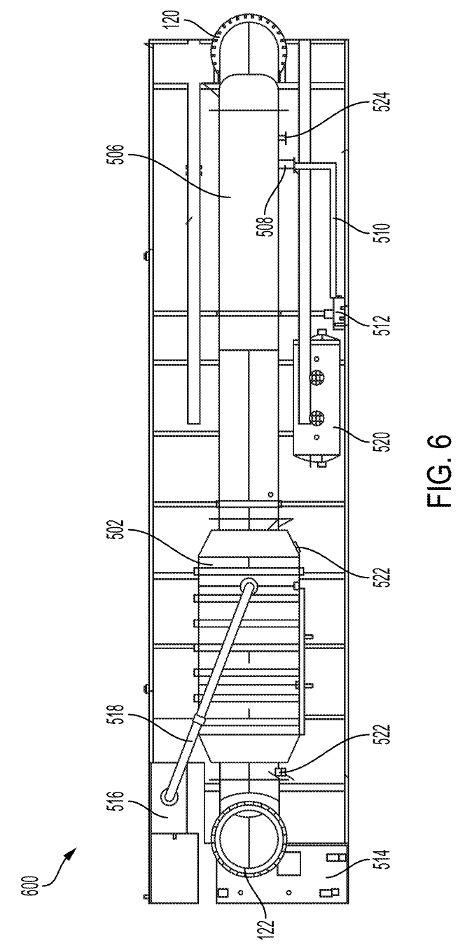

FIG. 6 is top view of an SCR system 600 that may be used in conjunction with a diesel generator set, as discussed herein. The SCR system 600 may include many of the same components as discussed in reference to the SCR system 500 of FIG. 5. For example, as depicted in FIG. 6, the SCR system 600 includes the exhaust inlet 120, exhaust outlet 122, SCR unit 502, reaction mixing section 506, injector 508, dosing line 510, doser box 512, reductant tank 514, heater 516, duct 518, expansion and cooling system 520, differential pressure sensors 522, and oxidation catalyst temperature sensor 524.

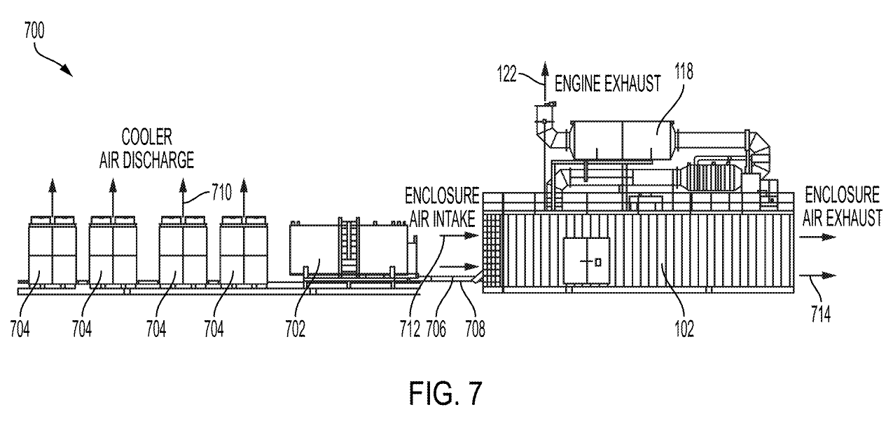

FIG. 7 is a side view of an alternative embodiment of a ultra-low NOx power generation system 700 (e.g., the ULN power generation system 700, the power generation system 700, or the system 700). The power generation system 700 includes many similar features of the power generation systems 100, 200 discussed herein, such as the enclosure 102, SCR subsystem 118, and exhaust output 122. The power generation system 700 may include an external fuel tank 702 positioned outside the enclosure 102. Unlike the fuel tank 126 of the power generation system 100 of FIG. 1, the external fuel tank 702 of FIG. 7 does not sit on the skid of the enclosure to be the base or the bottom of the enclosure 102. Instead, the external fuel tank 702 is disconnected from the enclosure 102 as a separate free-standing tank. Additionally illustrated in FIG. 6 are one or more coolers 704, also which may be positioned external to the enclosure 102. The one or more coolers 704 may receive hot air or hot liquid (e.g., water or coolant) from within the enclosure 102 and provide cooling in order to regulate temperature of the engine and other components associated with the system 700. The external fuel tank 702 may be connected to components within the enclosure 102 via one or more fuel pipes 706 that allows fuel to be pumped or otherwise flow to the engine within the enclosure 102. Similarly, the one or more coolers 704 may be connected to components within the enclosure via one or more cooling pipes 708 to allow air, liquid (e.g. water or coolant), etc. to be pumped or flowed between the one or more coolers 704 and components within the system 700.

Regarding air flow, the one or more coolers may output air discharge 710, which may allow heat to dissipate from the system 700. In at least one embodiment, the one or more coolers 704 may operate similarly to the radiator 114 discussed herein. Additionally, the enclosure 102 may have one or more enclosure air intakes 712 to allow fresh, cooler air to enter the enclosure 102, and the enclosure 102 may have one or more enclosure air outlets 714 to allow warmer air to leave the enclosure 102. The air intakes 712 or the air outlets 714 of the enclosure 102 may be equipped with one or more fans to direct air flow.

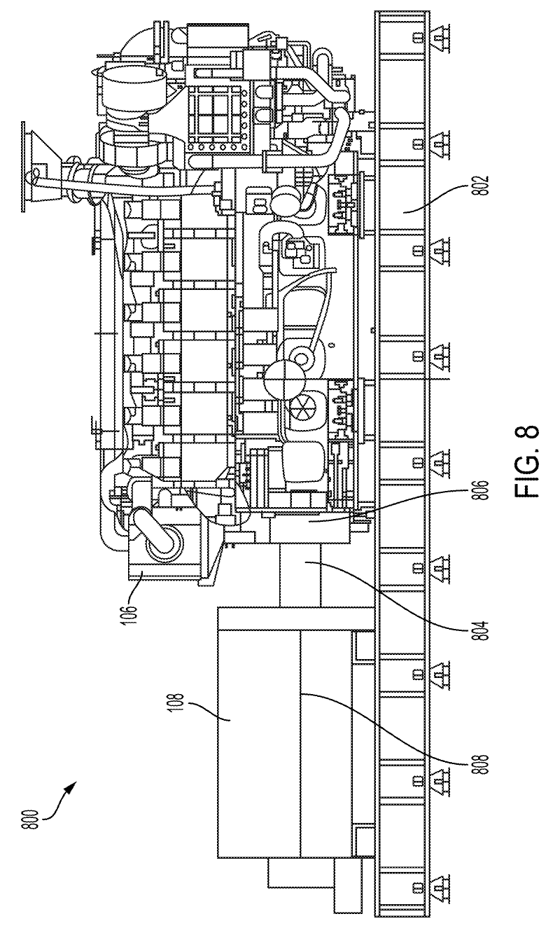

FIG. 8 illustrates a side view of a generator set 800 (e.g., genset 800) incorporated into the power generation systems of the present disclosure. The genset 800 may be secured to a skid 802, and the skid 802 may comprise the base of the enclosure discussed herein. As depicted in FIG. 8, the genset 800 includes the diesel engine 106 and the electrical generator 108, and the genset 800 may include a mechanical coupling 804 between the diesel engine 106 and the generator 108. The mechanical coupling 804 may allow the rotational power from the combustion occurring in the engine 106 to be transferred to the generator 108 so that electrical power can be produced in the generator 108. The mechanical coupling 804 may connect a crankshaft 806 of the engine 106 to a rotor shaft 808 of the generator 108, which enables torque and rotational speed from the engine 106 to directly drive the generator 108.

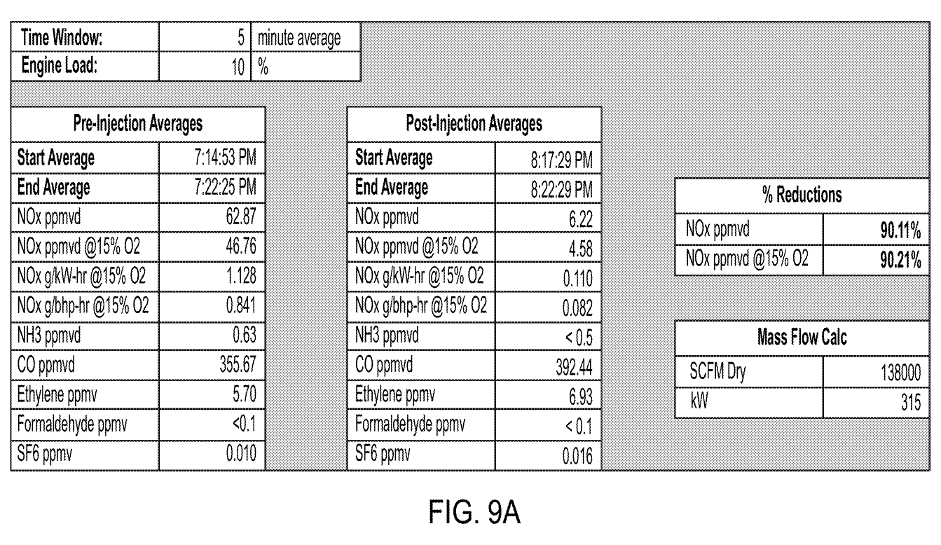

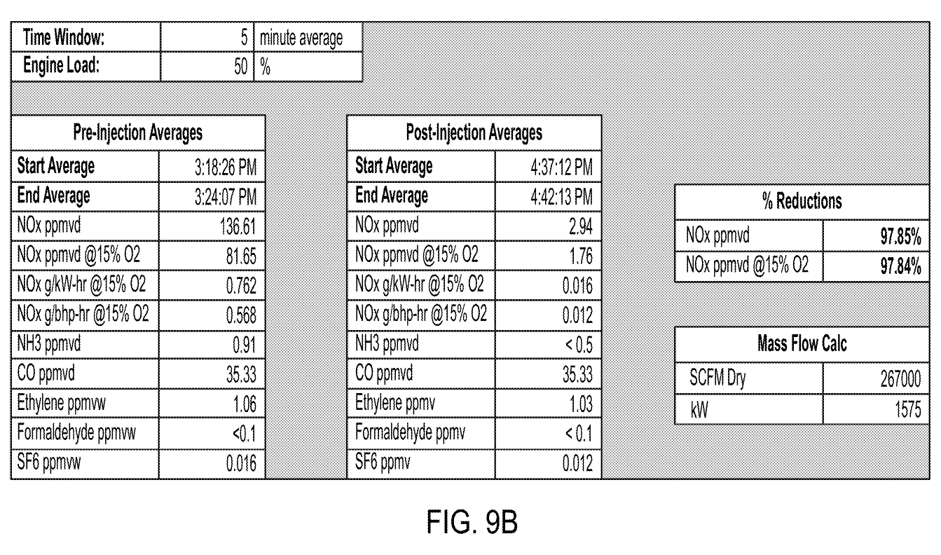

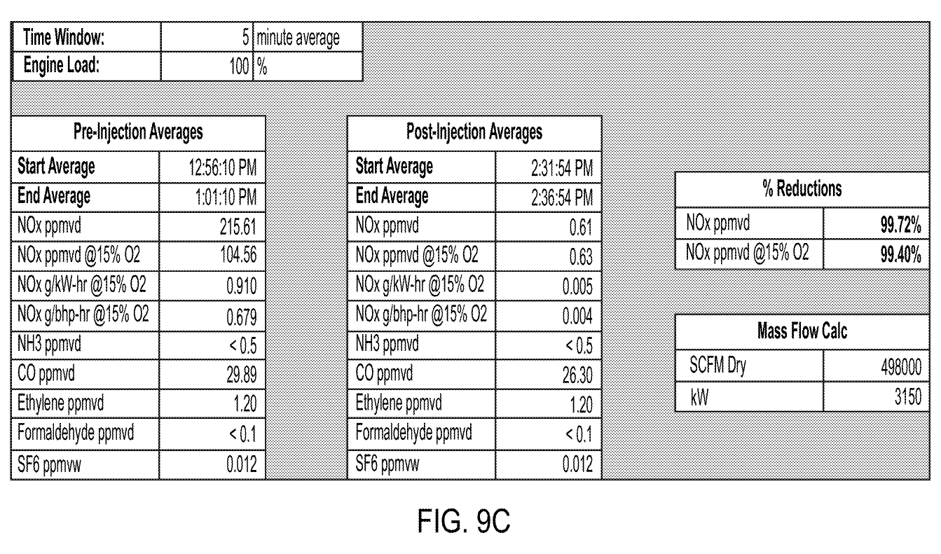

FIGS. 9A-9C present tables of pre-injection and post-injection averages of exhaust chemicals outputted from embodiments of systems discussed herein, running at 10%, 50%, and 100% engine load.

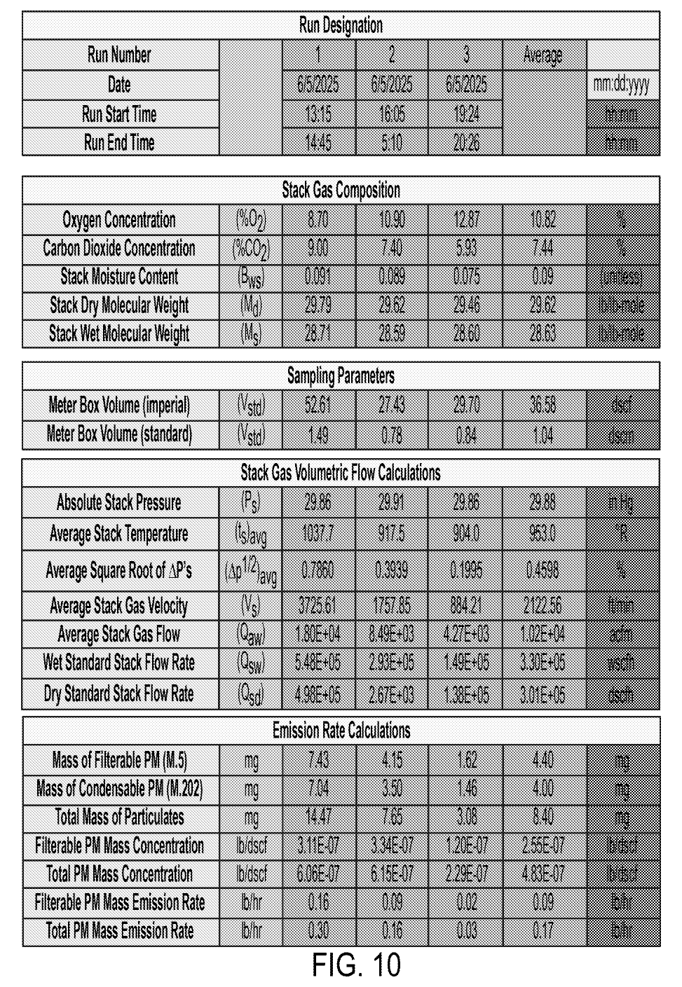

FIG. 10 presents tables of particulate matter mass concentrations and mass emission rates (both in filterable particulate matter and in total particulate matter) resulting from embodiments of systems discussed herein.

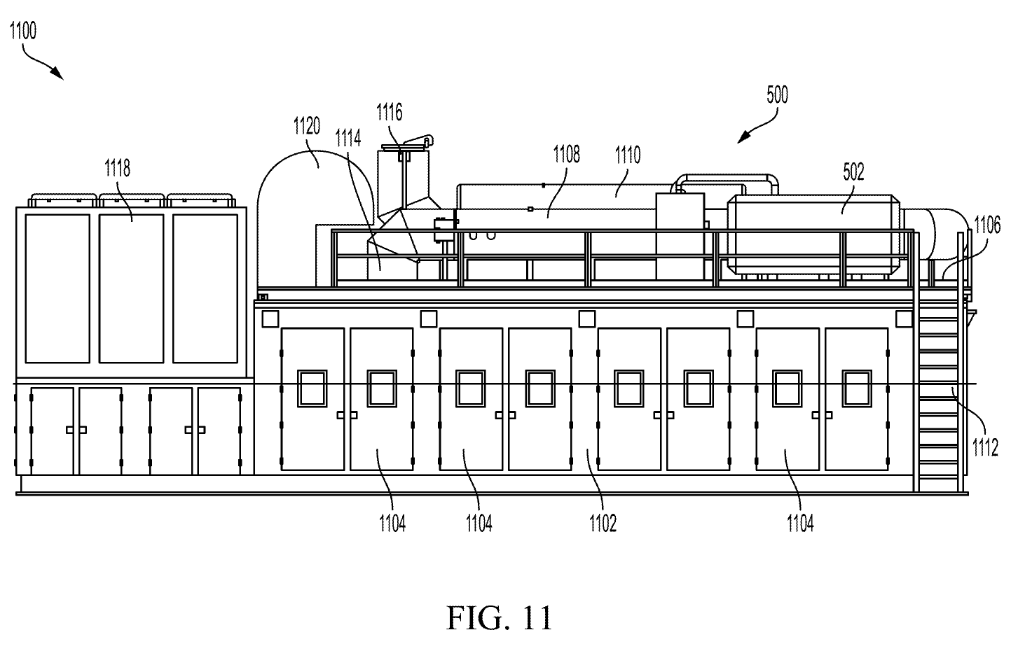

FIG. 11 is a front view of a containerized ultra-low NOx (ULN) generator set 1100 (e.g., containerized ULN genset 1100 or containerized genset 1100). The containerized ULN genset 1100 is provided in an enclosure 1102, which may have one or more access doors 1104 for personnel to access internal equipment. A generator or alternator (not depicted in FIG. 11) may be contained within the enclosure 1102, and an engine (not depicted in FIG. 11) may also be contained within the enclosure 1102; together, the generator/alternator and engine may form the genset that supplies power in various power generation applications.

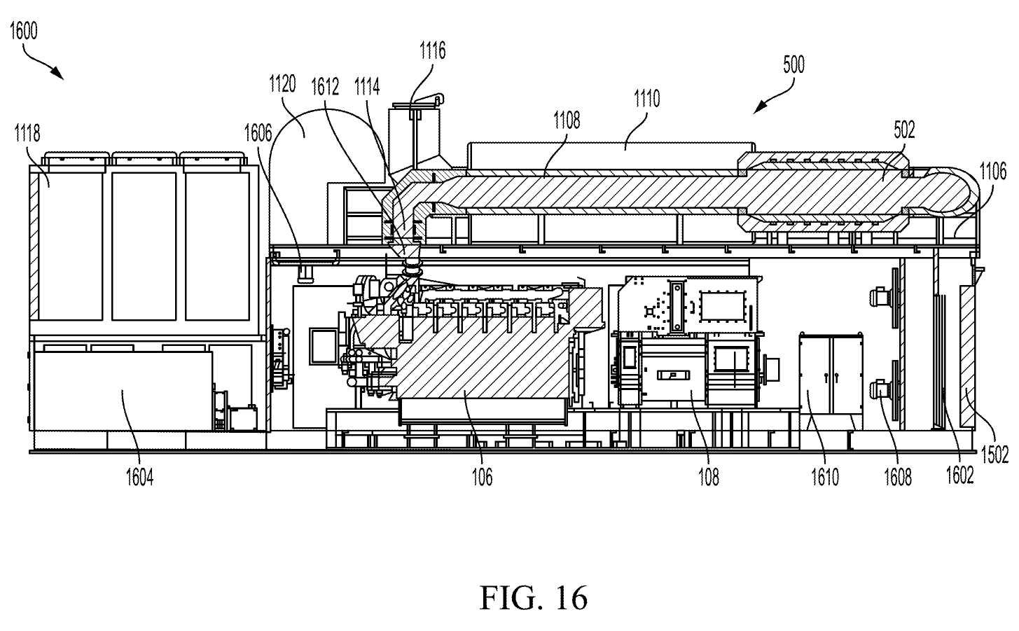

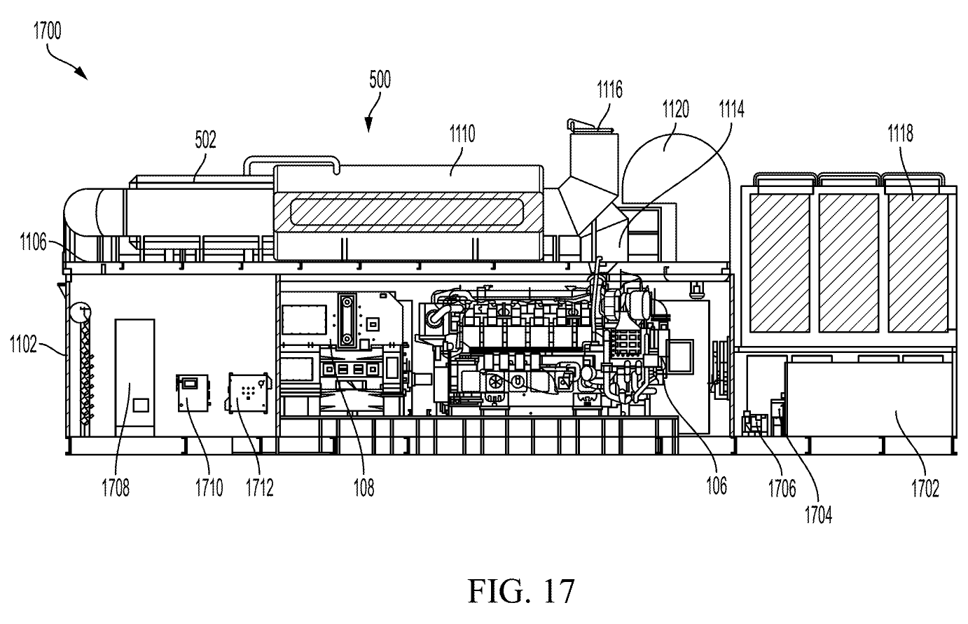

On the top of the containerized ULN genset 1100, there may be an SCR subsystem 500, as described herein, which may include an SCR unit 502, as depicted in FIG. 11. It should be appreciated that although the SCR subsystem 500 is positioned on top of the containerized genset 1100 in FIG. 11, the SCR subsystem 500 components may be on a separate skid and/or trailer, although such an arrangement is not required. However, mounting the SCR subsystem 500 on a roof 1106 of the containerized genset 1100 (on top of the containerized genset 1100) may be beneficial for a variety of packaging and operational reasons. For example, positioning the SCR subsystem 500 on the roof 1106 of the enclosure 1102 of the containerized genset 1100 may reduce the amount of interior space occupied within the enclosure 1102, thereby preserving room for the engine, generator/alternator, switchgear assemblies, and other equipment. A top-mounted SCR subsystem 500 may also facilitate routing of exhaust gases from the engine upwardly toward the SCR subsystem 500. For example, in the Wabtec 250 family of engines, the exhaust outlet is on the top of the engine toward the top of the interior of the enclosure 1102 (seen in more detail in FIGS. 16 and 17); therefore, positioning the SCR subsystem 500 directly above the enclosure 1102 may be the most efficient arrangement. Additionally, a top-mounted SCR subsystem 500 may help maintain components of the SCR subsystem 500 (e.g., the SCR unit 502 and the mixer 1108) within a temperature range conducive to reduction of NOx using ammonia and may improve exposure of the SCR subsystem 500 to ambient airflow for thermal dissipation. For example, if the SCR unit 502 operates at an excessively high temperature, ammonia may be undesirably oxidized and/or SCR efficiency may decrease, thereby reducing conversion of NOx. Therefore, in some embodiments, it may be untenable for the SCR unit 502 to be contained within the enclosure 1102. In at least one embodiment, locating the SCR subsystem 500 on the roof 1106 of the containerized genset 1100 may also reduce heat concentration within the enclosure 1102 thereby improve overall integration of the exhaust and the SCR subsystem 500.

The SCR subsystem 500 on the containerized genset 1100 may further include a mixing section 1108 (e.g., mixer 1108), which may be the location in which a reductant (e.g., aqueous ammonia) is injected to mix with the exhaust gases from the engine (as described herein). Also on top of the containerized ULN genset 1100, there may be an exhaust silencer 1110, which may function to muffle or suppress noise generated from the containerized genset. In some embodiments, the exhaust silencer 1110 may reduce sound energy associated with pulsations, pressure fluctuations, and other exhaust noise prior to discharge to the surrounding environment. Although shown on the top of the containerized genset 1100 in FIG. 11, the exhaust silencer 1110 may be mounted within the enclosure 1102, adjacent an exterior wall of the enclosure 1102, and/or partially outside of the enclosure 1102. Additionally, in order for personnel to access the top of the containerized ULN genset 1100 (e.g., for service, replacement, repair, inspections, etc.), on the outside of the enclosure 1102, a ladder 1112 may be installed on the right side of the containerized genset 1100. Although, it should be appreciated that some embodiments of the containerized genset 1100 may not include the ladder 1112. In at least one embodiment, a benefit of mounting the SCR subsystem 500 on the roof 1106 of the enclosure 1102 is that this arrangement may simplify access for inspection, maintenance, or replacement by personnel access via the ladder 1112.

Exhaust gas generated from the engine inside of the enclosure 1102 may enter the SCR subsystem 500 through an exhaust gas inlet 1114, then pass through the mixer 1108 to mix with the reductant, then enter the SCR unit 502 (which may contain a catalyst, as described herein), then pass through the silencer 1110 (which may reduce noise), and finally exit the SCR subsystem 500 through an exhaust gas outlet 1116, to be discharged into the surrounding atmosphere. Exhaust gas at the exhaust gas inlet 1114 may have levels of NOx and particulate matter (PM) that are EPA Tier 4 compliant, and once treated in the SCR subsystem 500, the exhaust gas exiting the exhaust gas outlet may contain amounts of NOx and PM lower than EPA Tier 4 compliant levels. If a failure within the SCR subsystem 500 occurs, the exhaust gas exiting the exhaust gas outlet 1116 may still be EPA Tier 4 compliant, since it is EPA Tier 4 compliant when exiting the engine (e.g., a Wabtec 250 family engine).

On the left side of FIG. 11, a cooling package 1118 may be positioned on the left side of the containerized genset 1100 and may be integrated into the containerized genset 1100 to provide thermal management for equipment disposed within the enclosure 1102. In some embodiments, the cooling package 1118 may provide cooling for the engine, the electrical generator, power electronics, switchgear assemblies, and/or other heat-generating systems of the containerized genset 1100. The cooling package 1118 may include one or more heat exchangers, radiators, charge-air coolers, fluid conduits, pumps, and/or fans configured to transfer heat from the equipment to ambient air. In some implementations, the cooling package 1118 may support multiple cooling loops or operating conditions, including a low-temperature cooling arrangement and a high-temperature cooling arrangement. The cooling package 1118 may further be configured to draw heated air from the enclosure 1102, discharge heated air from the enclosure 1102, and/or induce airflow through one or more ventilation openings so as to maintain desired operating temperatures for components housed within the enclosure 1102.

In at least one embodiment, the containerized genset 1100 further includes an exhaust hood 1120 positioned at or adjacent to an the exhaust gas inlet 1114 of the enclosure 1102. The exhaust hood 1120 may be configured to at least partially cover, surround, or overlie an opening through which engine exhaust is discharged from the interior of the enclosure 1102. The exhaust hood 1120 may define a protected discharge region that permits exhaust gases from the engine to exit the enclosure 1102 while reducing exposure of the outlet to rain, debris, and other environmental contaminants. In some embodiments, the exhaust hood 1120 may further direct the discharged exhaust gases away from one or more exterior surfaces of the container, air intake openings, service access locations, or personnel pathways.

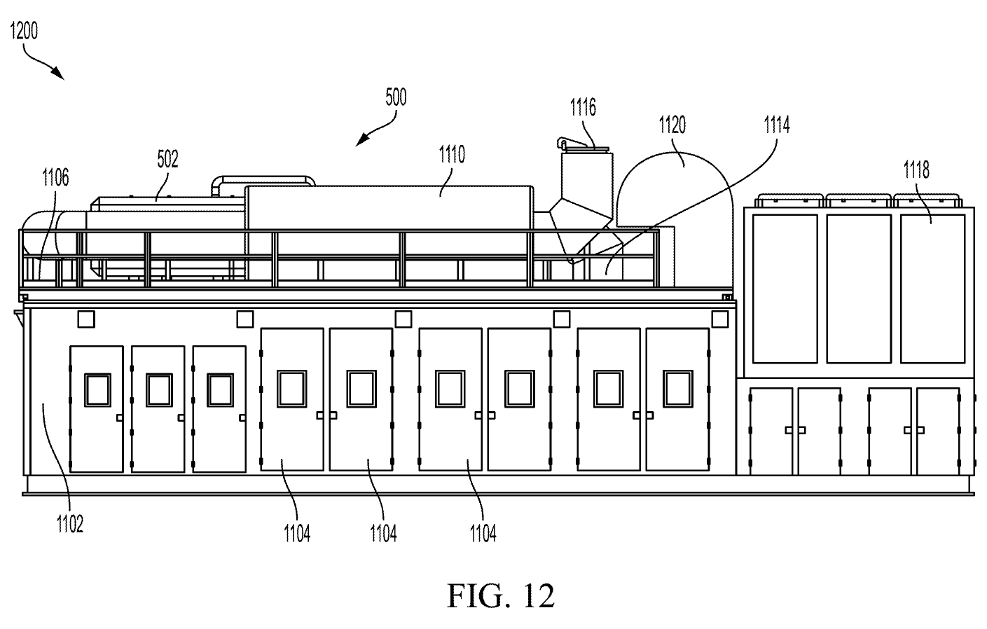

FIG. 12 is a rear view of a containerized ULN genset 1200, which may share many of the same features as the containerized ULN genset 1100 of FIG. 11. As shown in FIG. 12, the containerized ULN genset 1200 includes the enclosure 1102 with additional one or more access doors 1104 positioned along the rear side thereof to permit access to equipment housed within the enclosure 1102. As described herein, the enclosure 1102 includes a roof 1106, on top of which the SCR subsystem 500 is mounted. The SCR subsystem 500 may include the SCR unit 502 and the silencer 1110, which may be arranged generally as described above with respect to FIG. 11. The rear view of FIG. 12 also illustrates the exhaust gas inlet 1114 and the exhaust gas outlet 1116 associated with the SCR subsystem 500. In the illustrated embodiment, the cooling package 1118 is positioned at an end of the containerized ULN genset 1100, and the exhaust hood 1120 may be positioned between the SCR subsystem 500 and the cooling package 1118.

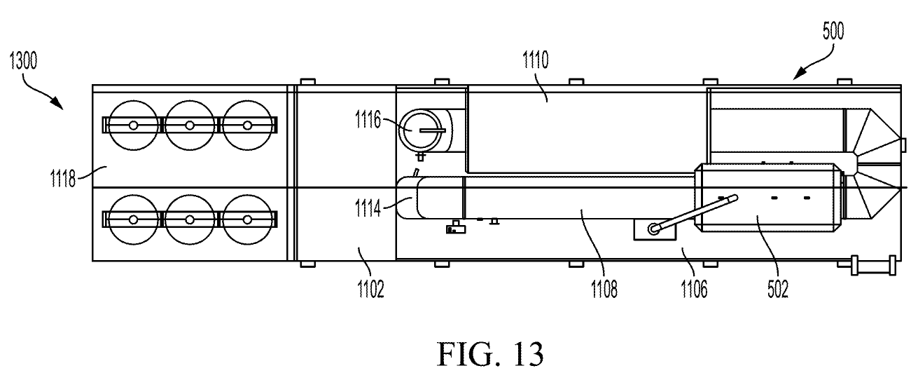

FIG. 13 is a top view of a containerized ULN genset 1300, which may share many of the same features as the containerized ULN genset 1100 of FIG. 11 and the containerized ULN genset 1200 of FIG. 12. As shown, the containerized ULN genset 1300 includes the enclosure 1102 having the roof 1106 with the SCR subsystem 500 mounted thereon, the SCR subsystem 500 including a mixer 1108, an SCR unit 502, and a silencer 1110 arranged along the top of the enclosure 1102. FIG. 13 further illustrates the relative position of the exhaust gas inlet 1114 and the exhaust gas outlet 1116. Also shown is the cooling package 1118 located at the left side of the containerized ULN genset 1300.

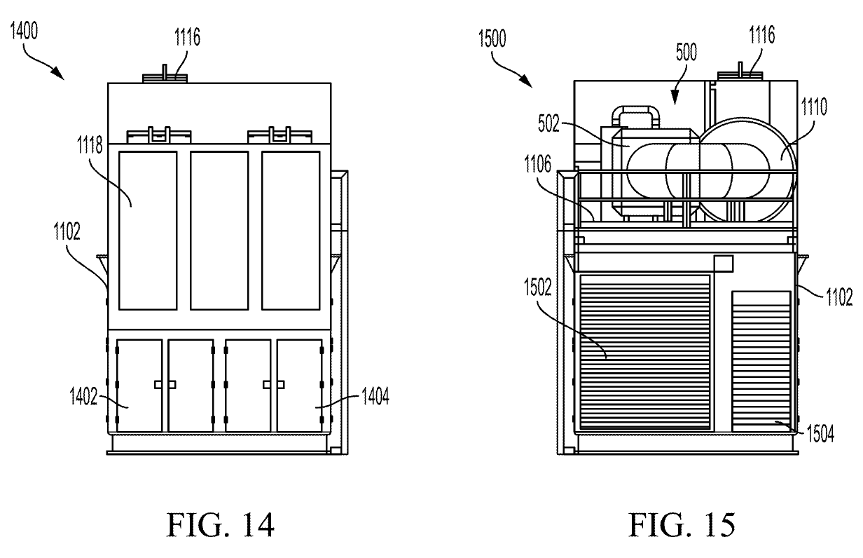

FIG. 14 is a left side view of a containerized ULN genset 1400, which may share many of the same features as the containerized ULN gensets 1100, 1200, 1300 of FIGS. 11-13, respectively. The left side view of FIG. 14 is shown with the cooling package 1118 in the foreground, and the exhaust gas outlet 1116 can be seen protruding from the top of containerized genset 1400. FIG. 14 further illustrates a first access region or door 1402 that may provide access to an ammonia tank and a second access region or door 1404 that may provide access to a fuel tank, thereby showing the left side view of how cooling, exhaust, and fluid-storage access points are integrated into the containerized ULN genset 1400.

FIG. 15 is a right side view of a containerized ULN genset 1400, which may share many of the same features as the containerized ULN gensets 1100, 1200, 1300, 1400 of FIGS. 11-14, respectively. The right side view of FIG. 15 illustrates the enclosure 1102 and roof 1106 supporting the SCR subsystem 500, including the SCR unit 502 and silencer 1110, with the exhaust gas outlet 1116 protruding from an upper portion of the containerized ULN genset 1500. FIG. 15 further illustrates one or more rain louvers 1502 and a plug panel 1504 positioned along the side of the enclosure 1102, thereby showing the right side view of how exhaust-treatment, ventilation, and electrical connection features are integrated into the containerized ULN genset 1500.

In some embodiments, the rain louvers 1502 may be configured to permit airflow into and/or out of the enclosure 1102 while inhibiting or reducing the ingress of rain, debris, and other environmental contaminants, and may include one or more slatted, angled, baffled, or louvered ventilation structures formed in or coupled to a wall of the enclosure 1102. In at least one embodiment, the plug panel 1504 may be configured to provide an external electrical interface for the containerized ULN genset 1500, such as for power output, auxiliary connections, control connections, testing, service, or temporary equipment hookup, and may include one or more receptacles, connectors, terminals, sockets, protective covers, and/or access panels arranged on an exterior portion of the enclosure 1102.

FIG. 16 is a partial cross-sectional front view of a containerized ULN genset 1600, which may share many of the same features as the aforementioned containerized ULN gensets of FIGS. 11-15. In the embodiment illustrated in FIG. 16, there are the louvers 1502 disposed in the right side wall of the containerized genset 1600, as well as a sand louver 1602 to the interior of the outer louvers 1502. In some embodiments, the sand louvers 1602 may be configured to permit airflow into and/or out of the enclosure while inhibiting or reducing the ingress of sand, dust, and other airborne particulate contaminants, and may include one or more slatted, angled, baffled, screened, filtered, or louvered ventilation structures formed inside the enclosure 1102.

From the partial cross-sectional view of the containerized ULN genset 1600, the engine 106 and generator 108 inside of the enclosure 1102 may be seen. Additionally, the containerized genset 1600 may include a fuel tank 1604, which, in at least one embodiment, has a capacity of about 3300 gallons; however, the fuel tank 1604 may be any other reasonable capacity, depending on the embodiment. The fuel tank 1604 may be fluidly coupled to the engine 106 such that fuel is able to be provided to the engine 106 for internal combustion. In the embodiment illustrated in FIG. 16, the fuel tank 1604 can be seen positioned below the cooling package 1118.

Furthermore, on the inside of the enclosure 1102, there may be one or more exhaust fans 1606 and/or one or more intake fans 1608. In the embodiment illustrated in FIG. 16, the one or more exhaust fans 1606 may be positioned below the exhaust hood 1120, and the one or more intake fans 1608 may be positioned to the interior of the louvers 1502 and sand louvers 1602. The one or more intake fans 1608 may be configured to draw ambient air into the enclosure, and the one or more exhaust fans 1606 may be configured to expel heated air, combustion byproducts, and/or ventilation air from the enclosure 1102, thereby promoting airflow and thermal management for components housed therein. In embodiments, the one or more intake fans 1608 and/or the one or more exhaust fans 1606 may include one or more electrically driven axial fans, centrifugal fans, blowers, or other forced-air ventilation devices. In embodiments, operation of the one or more intake fans 1608 and/or the one or more exhaust fans 1606 may be controlled using one or more soft starters configured to ramp the fan motors to a steady-state operating condition, one or more variable frequency drives (VFDs) configured to vary motor speed during startup and operation, and/or an across-the-line arrangement in which the fan motors are energized substantially at full load without a ramp-up period.

Also illustrated in FIG. 16 is a battery cabinet 1610 inside of the enclosure 1102, which may store various batteries or miscellaneous supplies and equipment. In addition, the view of FIG. 16 illustrates the relative position of the primary mover of the containerized ULN genset 1600, the engine 106. The engine 106 may have an engine exhaust 1612 on the top side of the engine 106 and positioned at the top of the inside of the enclosure 1102. The engine exhaust 1612 may be secured to or otherwise align with the exhaust gas inlet 1114 of the SCR subsystem 500 on the outside of the enclosure 1102 on the roof 1106, such that the exhaust gas generated by the internal combustion within the engine 106 is substantially routed into the SCR subsystem 500 for further emissions treatment. The cross-section of the flow path of the exhaust gas from the engine, to the engine exhaust 1612, to the exhaust gas inlet 1114, through the mixer 1108, and through the SCR unit 502 can be seen in FIG. 16.

FIG. 17 is a partial cross-sectional rear view of a containerized ULN genset 1700, which may share many of the same features as the aforementioned containerized ULN gensets of FIGS. 11-16. As a supplement to the partial cross-sectional front view of FIG. 16, the cross-section of the flow path of the exhaust gas through the silencer 1110 can be seen in FIG. 17. In the embodiment illustrated in FIG. 17, an ammonia tank 1702, with an ammonia air compressor 1704 and ammonia booster pump 1706 can be seen positioned below the cooling package 1118. In at least one embodiment, the capacity of the ammonia tank 1702 is about 1600 gallons; however, the ammonia tank 1702 may be any other reasonable capacity, depending on the embodiment. In some embodiments, the ammonia tank 1702 may be configured to store a reductant, such as ammonia, urea, an ammonia-containing fluid, or another reductant, for delivery to the SCR subsystem 500 described herein. The ammonia tank 1702 may be fluidly coupled to the ammonia air compressor 1704 and the ammonia booster pump 1706. The ammonia air compressor 1704 may be configured to provide compressed air for pressurization, transfer, atomization, and/or delivery of the reductant, for example, to the injector, dosing unit, the mixer 1108, or other portion of the SCR subsystem 500. The ammonia booster pump 1706 may be configured to increase pressure of the reductant for transport to one or more downstream components, such as an injector, dosing unit, the mixer 1108, or other portion of the SCR subsystem 500. As such, the reductant delivery and storage subsystem (e.g., the reductant subsystem)—which may include the ammonia tank 1702, ammonia air compressor 1704, and/or the ammonia booster pump 1706—may be fluidly coupled to one or more components of the SCR subsystem 500 (e.g., the mixer 1108).

Within the enclosure 1102 of the containerized genset 1700, there also may be a control assembly of controllers for various systems integrated within the overall containerized genset 1700 system. For example, the containerized genset 1700 may include a generator control/controller 1708, an SCR control/controller 1710, and/or a heater control/controller 1712. The generator controller 1708 may be configured to monitor, regulate, and/or control operation of an electrical generator 108 and/or associated engine 106 systems, including power generation, load response, protective functions, and communication with other control components of the containerized ULN genset 1700. The SCR controller 1710 may be configured to monitor, regulate, and/or control operation of the SCR subsystem 500, including reductant delivery, dosing, failure detection, and coordination of emissions-control functions. The heater controller 1712 may be configured to monitor, regulate, and/or control one or more heaters associated with the SCR subsystem 500, such as for temperature management and/or to maintain the SCR unit 502, the mixer 1108, fluids, lines, tanks, injectors, treatment elements, or other elements, within a desired operating temperature range.

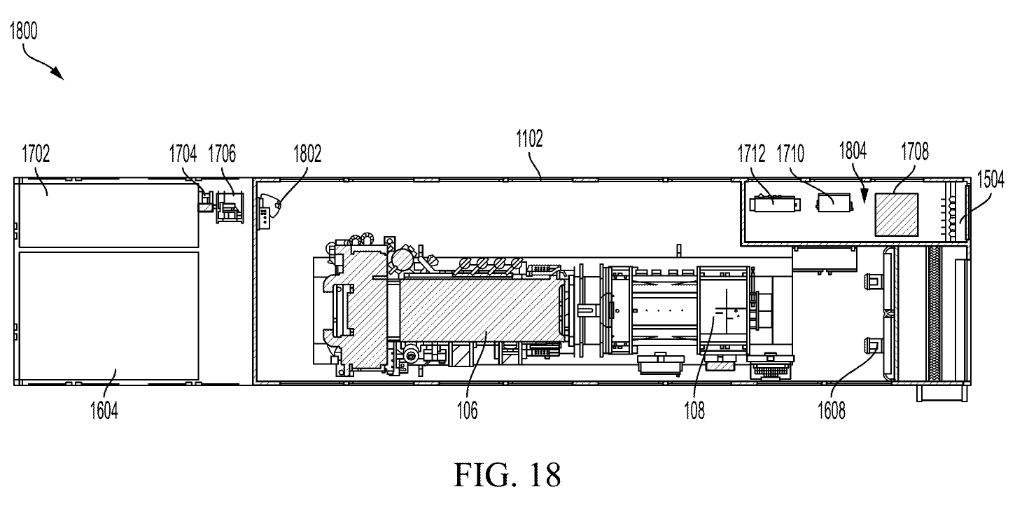

FIG. 18 is a partial cross-sectional top view of a containerized ULN genset 1800, which may share many of the same features as the aforementioned containerized ULN gensets of FIGS. 11-17. The fuel tank 1604 can be seen as positioned next to the ammonia tank 1702, however, this arrangement is not necessarily required. In addition, there may be a coolant/oil heater 1802 within the enclosure 1102, which, in an embodiment, may be controlled by the heater controller 1712. The coolant/oil heater 1802 may be operatively associated with the engine 106 and configured to heat engine coolant and/or engine oil, such as to facilitate engine starting, reduce cold-start wear, and/or maintain the engine 106 within a desired temperature range. Furthermore, proximate to the plug panel 1504, there may be a control area 1804. The control area 1804 may house the generator control 1708, the SCR control 1710, and/or the heater control 1712 for the containerized ULN genset 1800. In some embodiments, the control area 1804 is climate controlled.

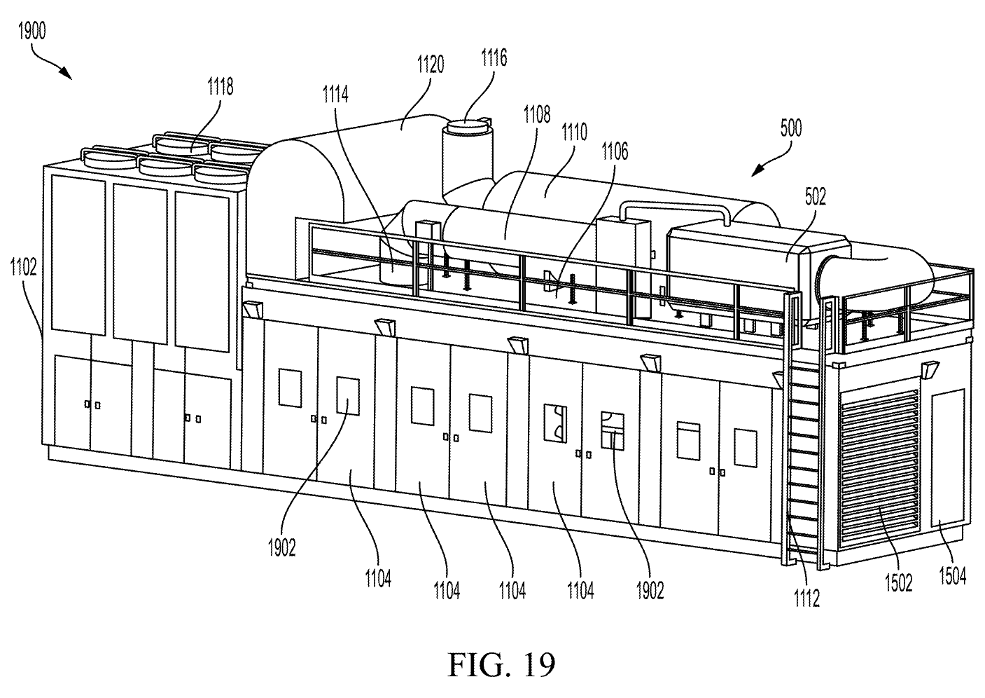

FIG. 19 is a perspective view of a containerized ULN genset 1900, which may share many of the same features as the aforementioned containerized ULN gensets of FIGS. 11-18. The perspective view of FIG. 19 also shows the relative position of the rain louvers 1502 and the plug panel 1504 on the right side of the containerized genset 1900, with the other external features of the containerized genset 1900. Accordingly, FIG. 19 illustrates a perspective view of the manner in which various external features are integrated into the containerized ULN genset 1900. Moreover, the containerized genset 1900 may include one or more inspection windows 1902, which may be integrated into the access doors 1104 of the enclosure 1102, and which may allow for visual inspection of the internal equipment and components of the containerized genset 1900 without requiring personnel to enter the enclosure 1102.

### Non‑limiting example embodiments

One or more embodiments of the present disclosure may further be described in view of the follow clauses associated with non-limiting example embodiments:
1. A diesel generator system comprising an engine, generator, SCR reactor, aqueous ammonia storage, injection system, and exhaust monitoring sensors to maintain exhaust temperature during ammonia injection.
2. The system of embodiment 1, wherein the aqueous ammonia mixture comprises approximately 10% ammonia and 90% water.
3. The system of any preceding embodiment, wherein control logic modulates injection rate based on temperature and NOx conversion targets to reduce ammonia slip.
4. The system of any preceding embodiment, further comprising an enclosure supporting an SCR unit and exhaust silencer.
5. The system of any preceding embodiment, integrated with switchgear and a power management system for generator plant operation.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A containerized generator set, comprising:
an enclosure comprising a roof and defining an interior;
an engine and an electrical generator disposed within the interior of the enclosure and configured to generate electrical power;
a selective catalytic reduction (SCR) subsystem mounted on the roof of the enclosure, the SCR subsystem comprising:
an exhaust gas inlet configured to receive exhaust gas from the engine;
a mixer configured to receive a reductant and to mix the reductant with the exhaust gas;
an SCR unit comprising a catalyst and configured to reduce NOx in the exhaust gas using the reductant; and
an exhaust gas outlet configured to discharge treated exhaust gas to atmosphere;
a flow path that directs exhaust gas from an engine exhaust exit of the engine substantially to the exhaust gas inlet of the SCR subsystem, through the mixer and the SCR unit, and out of the exhaust gas outlet; and
a cooling package coupled to the enclosure and configured to provide thermal management for equipment disposed within the enclosure.

2. The containerized generator set of claim 1, further comprising:
an exhaust silencer disposed in the flow path and configured to reduce exhaust noise prior to discharge to atmosphere.

3. The containerized generator set of claim 1, wherein the reductant is ammonia.

4. The containerized generator set of claim 1, further comprising:
a reductant subsystem fluidly coupled to the SCR subsystem and configured to store the reductant and deliver the reductant to the mixer.

5. The containerized generator set of claim 4, wherein the reductant subsystem comprises an ammonia tank fluidly coupled to at least one of an ammonia air compressor or an ammonia booster pump.

6. The containerized generator set of claim 1, wherein the engine exhaust exit is positioned proximate an upper region of the interior of the enclosure and aligned with the exhaust gas inlet of the SCR subsystem.

7. The containerized generator set of claim 1, further comprising:
an exhaust hood.

8. The containerized generator set of claim 1, wherein the cooling package comprises one or more heat exchangers, radiators, charge‑air coolers, fluid conduits, pumps, or fans configured to transfer heat from within the enclosure to the atmosphere.

9. The containerized generator set of claim 1, further comprising:
one or more intake fans disposed within the enclosure and configured to promote airflow in the enclosure by drawing ambient air into the enclosure from the atmosphere.

10. The containerized generator set of claim 9, further comprising:
one or more exhaust fans disposed within the enclosure and configured to promote airflow in the enclosure by expelling heated air from the enclosure to the atmosphere.

11. The containerized generator set of claim 9, further comprising:
one or more louvers formed in a wall of the enclosure and proximate to the one or more intake fans, wherein the one or more louvers are configured to permit airflow into the enclosure by the one or more intake fans, while inhibiting ingress of rain and particulate contaminants.

12. The containerized generator set of claim 10, wherein operation of the one or more intake fans or the one or more exhaust fans is controlled using at least one of a soft starter, a variable frequency drive, or an across‑the‑line operation.

13. The containerized generator set of claim 1, further comprising:
a plug panel on an exterior portion of the enclosure configured to provide an external electrical interface for at least one of power output, auxiliary connections, control connections, testing, service, or temporary equipment hookup.

14. The containerized generator set of claim 13, further comprising:
a control area within the enclosure proximate the plug panel and housing one or more controllers, the one or more controllers comprising at least one of a generator controller, an SCR controller, or a heater controller.

15. A containerized generator set with roof‑mounted SCR subsystem, comprising:
an enclosure comprising a roof and defining an interior housing an engine and an electrical generator; and
a selective catalytic reduction (SCR) subsystem mounted on the roof of the enclosure, the SCR subsystem comprising:
an exhaust gas inlet aligned with an engine exhaust exit of the engine, the exhaust gas inlet configured to receive the exhaust gas from the engine, wherein the exhaust gas comprises a first concentration of nitrogen oxides;
a mixer configured to receive a reductant and to mix the reductant with the exhaust gas;
an SCR unit comprising a catalyst and configured to reduce NOx in the exhaust gas to a second concentration of nitrogen oxides, wherein the second concentration of nitrogen oxides is lower than the first concentration of nitrogen oxides;
an exhaust silencer configured to reduce noise emitted from the containerized generator set; and
an exhaust gas outlet configured to discharge treated exhaust gases to atmosphere; wherein the SCR subsystem is arranged along the roof of the enclosure, wherein the arrangement routes the exhaust gas from the engine upwardly from the interior of the enclosure to the roof‑mounted SCR subsystem.

16. The containerized generator set with roof‑mounted SCR subsystem of claim 15, wherein the reductant is ammonia.

17. The containerized generator set with roof‑mounted SCR subsystem of claim 15, further comprising:
a reductant subsystem fluidly coupled to the SCR subsystem and configured to store the reductant and deliver the reductant to the mixer.

18. The containerized generator set with roof‑mounted SCR subsystem of claim 17, wherein the reductant subsystem comprises an ammonia tank fluidly coupled to at least one of an ammonia air compressor or an ammonia booster pump.

19. The containerized generator set with roof‑mounted SCR subsystem of claim 15, wherein the SCR subsystem is configured to meter and inject the reductant upstream of the SCR unit using an atomizing injector in the mixer.

20. The containerized generator set with roof‑mounted SCR subsystem of claim 15, further comprising:
sensors associated with the SCR subsystem configured to provide inputs to an SCR controller, the sensors comprising at least one of: upstream NOx, downstream NOx, catalyst temperature, exhaust temperature, exhaust flow, differential pressure across the SCR unit, reductant flow, or reductant pressure.
